(19) United States
(12) Patent Application Publication
(10) Pub. No.: US 2003/0067890 A1
(43) Pub. Date: Apr. 10, 2003

(54) System and method for providing automatic re-transmission of wirelessly transmitted information

(76) Inventors: Sandesh Goel, Mountain View, CA (US); Manish Airy, San Jose, CA (US); Partho Mishra, Cupertino, CA (US); Huzur Saran, San Jose, CA (US)

Correspondence Address: Patent Department, Iospan Wireless, P.O. Box 641867, San Jose, CA, 95164-1867, US

(21) Appl. No.: 09/975,128

(22) Filed: Oct. 10, 2001

(51) Int. Cl. H04B 7/00

(52) U.S. Cl. 370/310.1; 370/349

(57) ABSTRACT

The invention includes an apparatus and a method for wirelessly transmitting and re-transmitting sub-protocol data units between a transceiver and a subscriber unit. The method includes the transceiver receiving standard data units and forming sub-protocol data units. The transceiver transmits a plurality of sub-protocol data units to the subscriber unit. A subset of the plurality of sub-protocol data units includes an acknowledge request indicator. The subscriber unit receives the sub-protocol data units. The subscriber unit transmits back to the transceiver a response to the acknowledge request indicator, indicating which sub-protocol data units were successfully received by the subscriber unit.

### FIELD OF THE INVENTION

The invention relates generally to wireless communications. More particularly, the invention relates a method and system for efficiently re-transmitting information between a transceiver and a subscriber unit.

### BACKGROUND OF THE INVENTION

Wireless communication systems commonly include information carrying modulated carrier signals that are wirelessly transmitted from a transmission source (for example, a base transceiver station) to one or more receivers (for example, subscriber units) within an area or region.

FIG. 1 shows a portion of a single cell of a cellular wireless network system. A base transceiver station 110 provides a wireless connection to a plurality of subscriber units 120, 130, 140. The base transceiver station is generally connected to a network that provides access to the Internet. The cell of FIG. 1 is generally repeated forming a cellular network. The base transceiver station 110 and the subscriber units 120, 130, 140 include one or more antennas allowing two-way communication between the base transceiver station 110 and the subscriber units 120, 130, 140.

Generally, information is transmitted between the base transceiver station 110 and the subscriber units 120, 130, 140 in packets or units of data. Typically, a schedule or map must be generated that determines when the units of data are transmitted between base transceiver station 110 and subscriber units 120, 130, 140. The bandwidth of the available transmission frequencies is limited. Therefore, the transmission between multiple transceiver stations and subscriber units generally requires time, frequency, or some other type of multiplexing. The larger the number of base station transceivers and subscriber units, the more complex the scheduling or mapping.

The transmission can be time division duplex (TDD). That is, the down link transmission (transmission from the base transceiver station to a subscriber unit) can occupy the same channel (same transmission frequency) as the up link transmission (transmission from a subscriber unit to the base transceiver station), but occur at different times. Alternatively, the transmission can be frequency division duplex (FDD). That is, the down link transmission can be at a different frequency than the up link transmission. FDD allows down link transmission and up link transmission to occur simultaneously.

Generally, wireless systems are not as reliable as wired system. As a result, data being transferred between a base transceiver station and a subscriber can be miscommunicated or lost. This condition makes the scheduling difficult, because of difficulties in determining whether data must be rescheduled and retransmitted due to being lost. Tracking the information to be transferred at both the base transceiver station and at the subscriber unit aids in the management of the wireless transmission of data between the base transceiver station and the subscriber unit.

If information is detected as being lost, the transceiver unit can retransmit the information. A method for detecting whether or not information is lost includes a retransmission method know as Automatic Retransmit Query (ARQ) method.

A well-known ARQ method is the stop-and-wait ARQ method in which the source of the transmitted information stops and waits until a transmitted data packet is acknowledged. For each data packet, a positive acknowledgement (ACK) must be received from the destination, before a subsequent data packet can be transmitted from the source. If a negative acknowledgement is received from the destination, the source retransmits the same data packet again. If no acknowledgement is received, the source will automatically retransmit the same data packet after a timeout period.

The delay between the data packet transmission and the arrival of the acknowledgement information is known as a round trip delay. The round trip delay determines the data throughput of the network. The longer the round trip delay, the longer the source has to wait before it can transmit a new data packet. Therefore, the data throughput of the transmission link is inversely proportional to the round trip delay between the source and the destination. During the wait periods, the source is idle and no transmission takes place.

Generally, the transmitter unit include buffers in which data packets to be transmitted are stored before being transmitted. During the round trip delay periods, the transmitter unit receives additional data for transmission. Therefore, the buffers can be required to be very large, or the buffers can over-flow and cause incoming data to be lost.

Another limitation to the stop-and-wait ARQ method is that the transmission uplink from the subscriber unit to the transceiver unit can be stressed due to the fact that every data packet is confirmed as properly received.

It is desirable to have an apparatus and method that provides automatic wireless retransmission of information that was previously improperly transmitted. It is desirable that apparatus and method require less transmission buffering and less up-link transmission requirements. Additionally, it is desirable that buffers within in the transmitter by cleared as frequently as possible.

### SUMMARY OF THE INVENTION

The invention includes an apparatus and a method for automatic wireless re-transmission of information from a transceiver to subscriber unit. The apparatus and method includes an active acknowledge request for a subset of transmitted data units. Therefore, the invention requires less transmission buffering. Additionally, the invention does not stress uplink transmission from the subscriber unit to the transceiver as much as previous systems.

A first embodiment of the invention includes a method of wirelessly transmitting and re-transmitting sub-protocol data units between a transceiver and a subscriber unit. The method includes the transceiver receiving standard data units and forming sub-protocol data units. The transceiver transmits a plurality of sub-protocol data units to the subscriber unit. A subset of the plurality of sub-protocol data units includes an acknowledge request indicator. The subscriber unit receives the sub-protocol data units. The subscriber unit transmits back to the transceiver a response to the acknowledge request indicator, indicating which sub-protocol data units were successfully received by the subscriber unit.

The transceiver can include buffering of the sub-protocol data units within transceiver buffers. the transceiver transmits a sub-protocol data unit comprising the acknowledge request indicator when a last sub-protocol data unit within the transceiver buffers to be transmitted is reached. An embodiment includes the transceiver transmiting a sub-protocol data unit including the acknowledge request indicator when a predetermined number of sub-protocol data units have been transmitted since a previous sub-protocol data unit that comprised a previous acknowledge request indicator was transmitted.

A second embodiment of the invention is similar to the first embodiment. The second embodiment further includes a frequency in which sub-protocol data units including the acknowledge request indicator are transmitted is dependent upon a quality of wireless transmission link between the transceiver and the subscriber unit. Another embodiment includes how frequently sub-protocol data units including the acknowledge request indicator are transmitted is dependent upon a predetermined time duration since the transmitter received a response to an acknowledge request indicator. Another embodiment every transmitted sub-protocol data unit including an acknowledge request indicator after a predetermined time duration since the transmitter received a response to an acknowledge request indicator.

A third embodiment is similar to the first embodiment. The third embodiment includes the response to the acknowledge request includes a bit map that comprises information about which sub-protocol data units have been successfully received by the subscriber. Alternatively, the response to the acknowledge request includes a hole indicator that indicates which sub-protocol data units of a receiver window that includes a predetermined number of sub-protocol data units were not successfully received by the subscriber unit.

A fourth embodiment is similar to the first embodiment. The fourth embodiment includes the transceiver re-transmitting the sub-protocol data units that were not successfully received by the subscriber unit. The re-transmitted sub-protocol data units can be provided with a different transmission priority than sub-protocol data unit that have not yet been transmitted. The re-transmitted sub-protocol data units can be provided with a different transmission mode than sub-protocol data unit that have not yet been transmitted. The re-transmitted sub-protocol data unit can be transmitted over a better of multiple transmission channels of a multiple antennae transmitter.

A fifth embodiment is similar to the first embodiment. The fifth embodiment includes the transceiver aborting a transceiver buffer of sub-protocol data units if a response to an acknowledge request is not received after a given period of time. Another embodiment includes the transceiver clearing a present transceiver buffer when the response to the acknowledge request has been received, and all sub-protocol data units have been successfully received by the subscriber unit.

A sixth embodiment is similar to the first embodiment. The sixth embodiment includes the subscriber unit including a subscriber buffer in which received sub-protocol data units are buffered. The subscriber unit can abort the subscriber buffer of received sub-protocol data units if sub-protocol data units with errors are not correctly retransmitted after a given period of time. The subscriber unit can transmit a pseudo response to an acknowledgement indicator if the subscriber fails to receive re-transmitted sub-protocol data units.

A seventh embodiment includes method of wirelessly transmitting and re-transmitting sub-protocol data units from a transceiver. The method includes the transceiver receiving standard data units and forming sub-protocol data units. The transceiver transmits a plurality of sub-protocol data units to a subscriber unit, a subset of the plurality of sub-protocol data units include an acknowledge request indicator. The transceiver receives a response to at least one acknowledge request indicator, each response including an indication of which sub-protocol data units were successfully received by the subscriber unit. The transceiver re-transmits the sub-protocol data units that were not successfully received by the subscriber unit.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a prior art wireless system that includes a transceiver and multiple subscriber units.

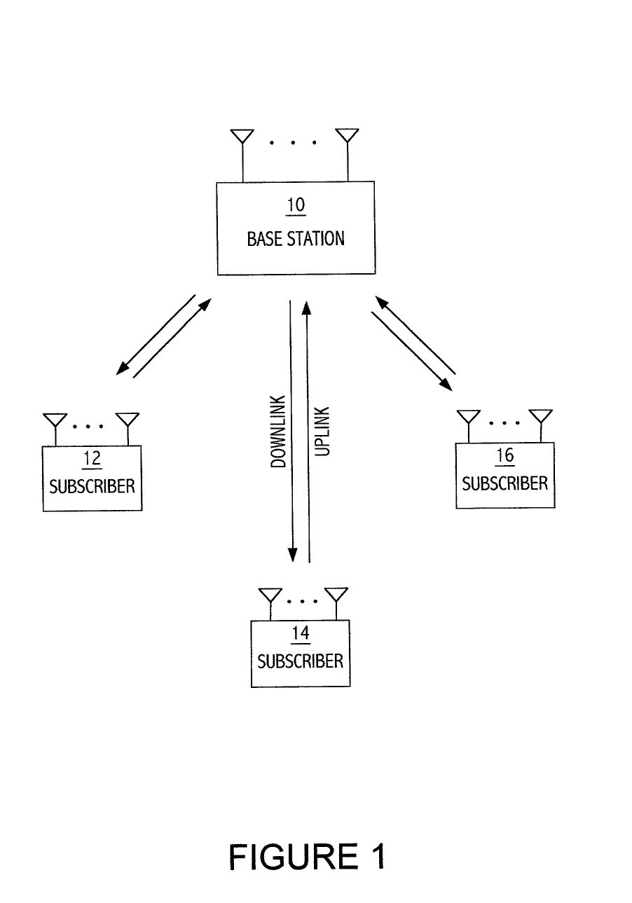

FIG. 2 shows an embodiment of a transmitter according to the invention.

FIG. 3 shows an embodiment of a receiver according to the invention.

FIG. 4 is a flow chart showing acts included within an embodiment of the invention.

### DETAILED DESCRIPTION

As shown in the drawings for purposes of illustration, the invention is embodied in an an apparatus and a method for automatic wireless re-transmission of information from a transceiver to subscriber unit. The apparatus and method includes an active acknowledge request for a subset of transmitted data units. Therefore, the invention requires less transmission buffering. Additionally, the invention does not stress uplink transmission from the subscriber unit to the transceiver as much as previous systems.

Particular embodiments of the present invention will now be described in detail with reference to the drawing figures. The techniques of the present invention may be implemented in various different types of wireless communication systems. Of particular relevance are cellular wireless communication systems. A base station transmits downlink signals over wireless channels to multiple subscribers. In addition, the subscribers transmit uplink signals over the wireless channels to the base station. Thus, for downlink communication the base station is a transmitter and the subscribers are receivers, while for uplink communication the base station is a receiver and the subscribers are transmitters. Subscribers may be mobile or fixed. Exemplary subscribers include devices such as portable telephones, car phones, and stationary receivers such as a wireless modem at a fixed location.

The base station can include multiple antennas that allow antenna diversity techniques and/or spatial multiplexing techniques. In addition, each subscriber can be equipped with multiple antennas that permit further spatial multiplexing and/or antenna diversity. Single Input Multiple Output (SIMO), Multiple Input Single Output (MISO) or Multiple Input Multiple Output (MIMO) configurations are all possible. In any of these configurations, the communications techniques can employ single-carrier or multi-carrier communications techniques. Although the techniques of the present invention apply to point-to-multipoint systems, they are not limited to such systems, but apply to any wireless communication system having at least two devices in wireless communication. Accordingly, for simplicity, the following description will focus on the invention as applied to a single transmitter-receiver pair, even though it is understood that it applies to systems with any number of such pairs.

Point-to-multipoint applications of the invention can include various types of multiple access schemes. Such schemes include, but are not limited to, time division multiple access (TDMA), frequency division multiple access (FDMA), code division multiple access (CDMA), orthogonal frequency division multiple access (OFDMA) and wavelet division multiple access.

The transmission can be time division duplex (TDD). That is, the downlink transmission can occupy the same channel (same transmission frequency) as the uplink transmission, but occur at different times. Alternatively, the transmission can be frequency division duplex (FDD). That is, the downlink transmission can be at a different frequency than the uplink transmission. FDD allows downlink transmission and uplink transmission to occur simultaneously.

Typically, variations of the wireless channels cause uplink and downlink signals to experience fluctuating levels of attenuation, interference, multi-path fading and other deleterious effects. In addition, the presence of multiple signal paths (due to reflections off buildings and other obstacles in the propagation environment) causes variations of channel response over the frequency bandwidth, and these variations may change with time as well. As a result, there are temporal changes in channel communication parameters such as data capacity, spectral efficiency, throughput, and signal quality parameters, e.g., signal-to-interference and noise ratio (SINR), and signal-to-noise ratio (SNR).

Information is transmitted over the wireless channel using one of various possible transmission modes. For the purposes of the present application, a transmission mode is defined to be a particular modulation type and rate, a particular code type and rate, and may also include other controlled aspects of transmission such as the use of antenna diversity or spatial multiplexing. Using a particular transmission mode, data intended for communication over the wireless channel is coded, modulated, and transmitted. Examples of typical coding modes are convolution and block codes, and more particularly, codes known in the art such as Hamming Codes, Cyclic Codes and Reed-Solomon Codes. Examples of typical modulation modes are circular constellations such as BPSK, QPSK, and other m-ary PSK, square constellations such as 4QAM, 16QAM, and other m-ary QAM. Additional popular modulation techniques include GMSK and m-ary FSK. The implementation and use of these various transmission modes in communication systems is well known in the art.

The Transceiver (Base Station)

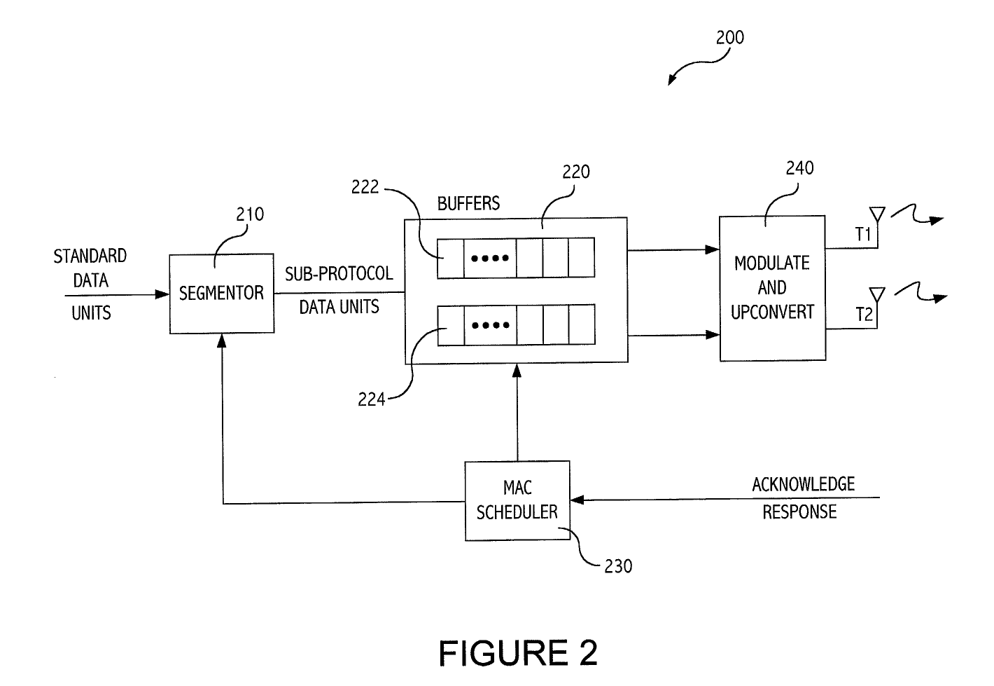

FIG. 2 shows an embodiment of a transceiver 200 according to the invention. The transceiver 200 receives standard protocol data units (PDU's). The PDU's are divided into smaller sub-protocol data units that are stored in transceiver buffers 222, 224 of a buffer unit 220.

A segementer unit 210 within the transceiver 200 receives the protocol data units from a standard computer network. The protocol data units can be Ethernet frames, ATM cells or IP packets. The segementer unit 210 divides the protocol data units into smaller sub-protocol data units that are more adaptable for transmission within wireless communication systems. Smaller sub-protocol data units facilitate error recovery through retransmission.

The digital circuitry required to divide or break large groups of data into smaller groups of data is well known in the art of digital circuit design.

The transceiver 200 further includes a media access control (MAC) scheduler 230. The MAC scheduler 230 generates a map that designates time slots and frequency block in which the sub-protocol data units are to be transmitted from the transceiver 200 to receiver (subscriber) units (down link), and time slots and frequency blocks in which other sub-protocol data units are to be transmitted from the receiver (subscriber) units to the transceiver 200 (up link).

The buffers 222, 224 within the transceiver 200 receive and buffer the sub-protocol data units. The placement and priority of transmission of the sub-protocol data units within the buffers 222, 224 is determined by the MAC scheduler 230. In FIG. 2, the buffer unit 220 includes a first buffer 222 and second buffer 224. The two buffers 222, 224 are intended to represent the buffering of sub-protocol data units that are to be transmitter from two separate transmit antennae T1 and T2.

After the sub-protocol data units are stored within buffers 222, 224, the sub-protocol data units are transferred to a modulate and upconvert unit 240. The modulate and upconvert unit 240 modulates carrier signals with streams of sub-protocol data units from the buffers 222, 224. The modulated carriers are then transmitted from the transmit antennae T1, T2.

The embodiment of FIG. 2 includes two buffers 222, 224 and two transmit antennae T1, T2. However, it is to be understood that this is merely an example of an implementation of the invention.

The MAC scheduler 230 generates a map or schedule of transmission of the sub-protocol data. This includes when and at what frequency range sub-protocol data units are to be received by the receiver (subscriber) unit, and when and at what frequency range the receiver (subscriber) units transmit sub-protocol data units back to the transceiver 200. The map is transmitted to the receiver (subscriber) units so that each receiver (subscriber) unit knows when to receive and transmit sub-protocol units. A map is transmitted once per a unit of time that is generally referred to as a frame. The time duration of the frame is variable.

The MAC scheduler 230 receives information regarding the quality of transmission links between the transceiver 200 and the receiver (subscriber) units. The quality of the links can be used to determine whether the transmission of data to a particular receiver should include spatial multiplexing or communication diversity. Additionally, the MAC scheduler 230 receives data requests from the receiver (subscriber) units. The data requests include information regarding the size of the data request, and the data type of the data request. The scheduler includes the link quality information, the data size, and the data type for generating the schedule.

Acknowledge Request Indicator

An embodiment includes the sub-protocol data units each having an acknowledge request indicator. The acknowledge request indicator of each sub-protocol data unit can be set to active or non-active. If the acknowledge request indicator of a sub-protocol data unit is set to active, the subscriber unit that receives the sub-protocol data unit is directed to transmit back to the transceiver a status of the sub-protocol data units that have been received by subscriber unit.

The sub-protocol data units are separately identifiable through a numbering sequence associated with each of the sub-protocol data units. When a subscriber unit receives a sub-protocol data unit that includes an actively set acknowledge request indicator, the subscriber unit transmits back to the transceiver the sequence number associated with the sub-protocol data units that were successfully received by the subscriber unit. The transceiver can then retransmit sub-protocol data units that were not successfully received by the subscriber unit. Again, the subscriber only transmits the status of sub-protocol data units upon reception by the subscriber unit of a sub-protocol data unit with an active acknowledge request indicator.

Retransmitted sub-protocol data units can be designated as having a higher priority than other sub-protocol data units. The priority designation can be reflected within the scheduling of the MAC scheduler 230. The priority designation can also influence the mode selection of the retransmitted sub-protocol data units.

Additionally, the priority designation can be used to direct the retransmission of a sub-protocol data unit through a channel of a multiple channel (multiple antennae) system that is better than the channel the sub-protocol data unit was originally transmitted. For example, the transceiver 200 of FIG. 2 includes the two separate transmit antennae T1 and T2. Each transmitter antenna forms a transmission channel with antennae of the subscriber unit. Therefore, the transceiver of FIG. 2 will naturally have at least two separate transmission channels. The retransmission of sub-protocol data bits can be directed through the better channel, making it more likely that the retransmitted sub-protocol data units will be properly received by the subscriber unit. A better channel is generally defined by the quality of the transmission link or channel. The quality can be determined by the SNR, the SINR, the bit error rate (BER) or the packet error rate (PER). These quality parameters, as is well know in the art of communication systems, can be determined at the subscriber unit and transmitted through the uplink to the transceiver.

An embodiment of the modulate and upconvert unit 240 generates a plurality of multiple-carrier modulated signals. The multiple-carrier modulated signals are frequency up-converted and amplified as is well known in the art of communication systems. The multiple-carrier modulated signals can include orthogonal frequency division multiplexing (OFDM).

The Subscriber (Receiver) Unit

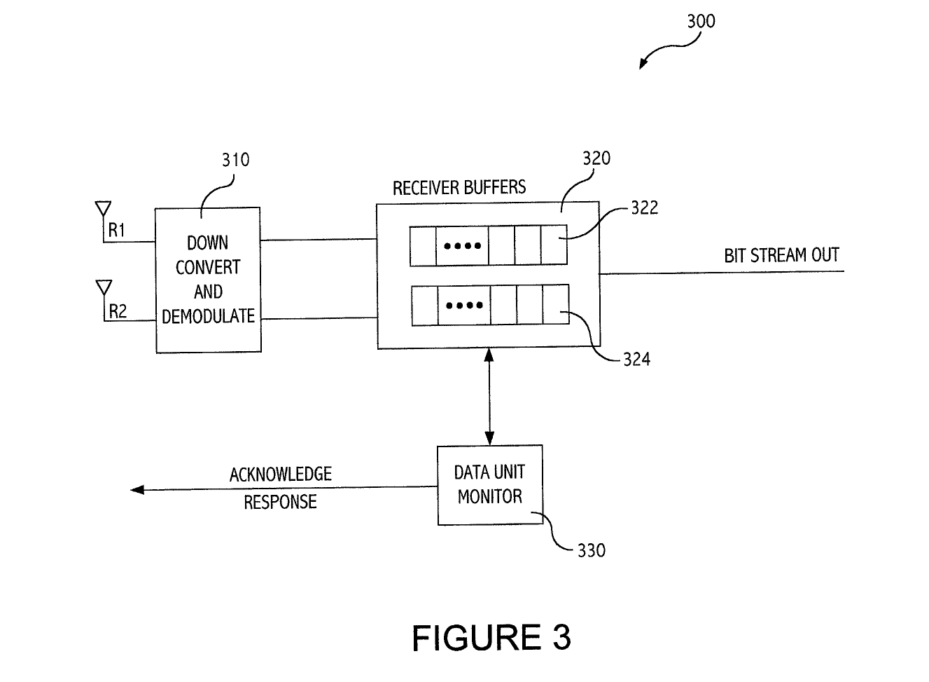

FIG. 3 shows a subscriber (receiver) unit 300 according to the invention. The subscriber unit 300 receives signals transmitted from the transceiver. FIG. 3 shows two receive antennae R1, R2 receiving the modulated signals. A down convert and demodulate unit 310 frequency down converts and demodulates the received signals.

Streams of sub-protocol data units generated by the down convert and demodulate unit 310 are stored within receiver buffers 322, 324 of a buffer unit 320. A data unit monitor 330 monitors reception of the sub-protocol data units, and recognizes when sub-protocol data units having an active acknowledge request are received by the subscriber unit. Generally, this can include merely observing whether a single acknowledge request bit is set active.

When the data unit monitor 330 detects an active acknowledge request indicator within a sub-protocol data unit, the data unit monitor 330 determines which of the sub-protocol data units within the receive buffers 322, 324 were properly received. A response to a received active acknowledge request indicator is sent (generally through uplink transmission) to the transceiver indicating which sub-protocol data units were properly received. Various well-known techniques can be employed to determine whether sub-protocol data units properly received. For example, the determination can be made through Reed Solomon decoding a standard CRC (cyclic redundancy check) or a combination of the two.

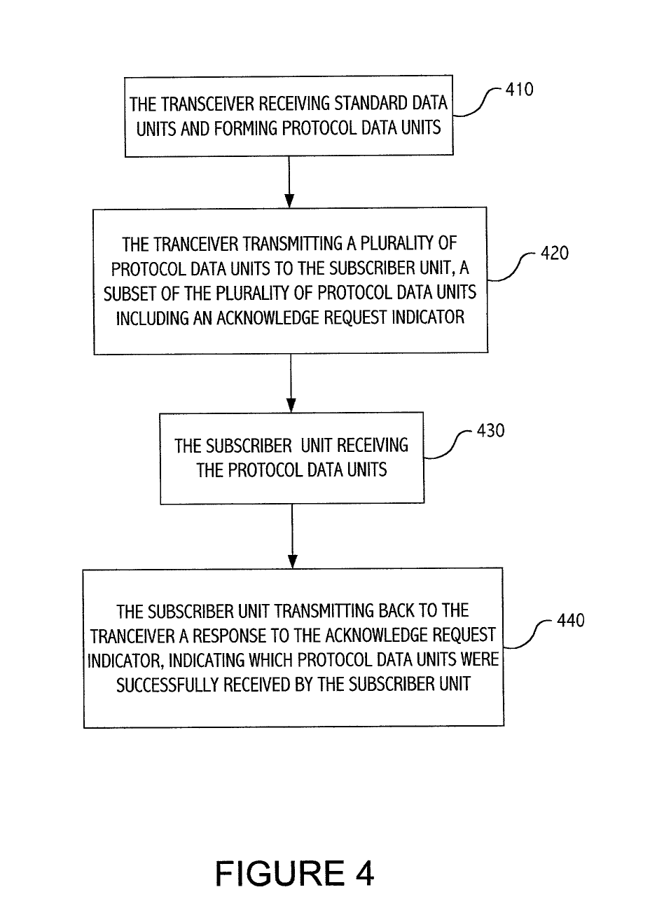

FIG. 4 is a flow chart depicting acts included within an embodiment of the invention. The embodiment includes wirelessly transmitting and re-transmitting sub-protocol data units between a transceiver and a subscriber unit.

A first act 410 includes the transceiver receiving standard data units and forming sub-protocol data units. The transceiver generally includes transceiver buffers for buffering the sub-protocol data units.

A second act 420 includes the transceiver transmitting a plurality of sub-protocol data units to the subscriber unit, a subset of the plurality of sub-protocol data units including an acknowledge request indicator.

There are several advantages to only including the acknowledge request indicator with a subset of the sub-protocol data units rather than with all of the sub-protocol data units. The subscriber unit must generate a response for each protocol data unit that includes an active acknowledge request indicator. If every sub-protocol data unit includes an active acknowledge request indicator, then a response must be generated for every sub-protocol data unit. This can strain the up-link traffic flow. Minimizing the number of sub-protocol data units having active acknowledge request indicators reduces the stress on the up-link traffic. As will be described later, techniques can be implemented that allow for minimization of the size of the buffers within the transmitter.

The acknowledge request indicator can be set active when a last sub-protocol data unit within the transceiver buffers to be transmitted is reached, or the acknowledge request indicator can be set active when a predetermined number of sub-protocol data units have been transmitted since a previous sub-protocol data unit that comprised a previous acknowledge request indicator was transmitted. The frequency or time duration in which sub-protocol data units including an actively set acknowledge request indicator are transmitted can be dependent upon a quality of wireless transmission link between the transceiver and the subscriber unit. Alternatively, a frequency or time duration in which sub-protocol data units including an actively set acknowledge request indicator are transmitted is dependent upon a predetermined time duration since the transmitter received a response to an acknowledge request indicator. For example, if a predetermined duration of time has passed since the transceiver has received a response to an acknowledge request indicator, then an active acknowledge request indicator can be including within every transmitted sub-protocol data unit.

A third act 430 includes the subscriber unit receiving the sub-protocol data units. That is, the sub-protocol data units are transmitted by the transceiver and received by the subscriber unit.

A fourth act 440 includes the subscriber unit transmitting back to the transceiver a response to the acknowledge request indicator, an indication of which sub-protocol data units were successfully received by the subscriber unit. The response to the acknowledge request can include a bit map that includes information about which sub-protocol data units have been successfully received by the subscriber. The response to the acknowledge request can include a hole indicator that indicates which sub-protocol data units of a receiver window that includes a predetermined number of sub-protocol data units were not successfully received by the subscriber unit.

A bit map response generally includes many bits in which each bit represents a particular sub-protocol data unit location within a buffer of a subscriber unit. Each bit indicates whether the corresponding sub-protocol data unit was properly received. Generally, the size of the bit map equals the size (that is, number of sub-protocol data units) of the buffer (also termed the re-assembly buffer) of the subscriber unit.

The transmission errors of a wireless transmission system are generally bursty. That is, there is a high probability that an improperly received sub-protocol data unit will be followed by another improperly received sub-protocol data unit. It is generally more efficient (especially on the up-link transmission) to indicate the locations of a series of improperly received sub-protocol data units (that is, “holes”) than to individually identify each sub-protocol data unit. Therefore, efficient transmission includes the response including a hole indicator that merely indicates the locations of one or more improperly received sub-protocol data units.

The transceiver re-transmits the sub-protocol data units that were not successfully received by the subscriber unit. The re-transmitted sub-protocol data unit can be provided with a different transmission priority than sub-protocol data unit that have not yet been transmitted. The re-transmitted sub-protocol data unit can be provided with a different transmission mode than sub-protocol data unit that have not yet been transmitted. The re-transmitted sub-protocol data unit can be transmitted over a better of multiple transmission channels of a multiple antennae transmitter.

Several different situations provide clearing the buffers within either the transceiver or the subscriber units.

The transceiver can abort a transceiver buffer of sub-protocol data units if a response to an acknowledge request is not received after a given period of time. Situations can arise in which the transceiver will never receive a response to an acknowledge request. In these situations, the transceiver can abort a present buffer of sub-protocol data units to prevent the transceiver from being completely tied up due to the transceiver not receiving a response from a single subscriber.

The transceiver can clear a present transceiver buffer when the response to an acknowledge request has been received, and all sub-protocol data units have been successfully received by the subscriber unit. That is, once all of the sub-protocol data units within the buffers of a transceiver have been successfully received by the subscriber unit, there is no reason to maintain the sub-protocol data units within the buffers of the transceiver.

The transceiver can selectively clear a present transceiver buffer after receiving a response to an acknowledge request. As previously mentioned, the response to an acknowledge request includes information regarding which sub-protocol data units were successfully received by the subscriber unit. The successfully received sub-protocol data units a cleared from the transceiver buffer.

As previously described, the subscriber unit includes buffers for the received sub-protocol data units. An embodiment of the invention includes aborting the subscriber buffer of received sub-protocol data units if sub-protocol data units not properly received by the subscriber unit are not correctly retransmitted after a given period of time. This can accommodate for situations including a transmission link in which sub-protocol data unit will never be properly received, or a situation in which the transceiver never receives a response to an acknowledge request indicator from the subscriber unit.

Another embodiment includes the subscriber unit transmitting a pseudo response to an active acknowledgement indicator if the subscriber fails to receive re-transmitted sub-protocol data units. This procedure can be used to prevent the subscriber unit from being tied up during a period in which the transmission link between the transceiver and the subscriber unit is poor.

It is desirable to limit the maximum amount of time required to transmit a protocol data unit from a transceiver to a subscriber unit. Transmitting a pseudo response to an active acknowledgement indicator can be useful when the maximum amount of time required to transmit a protocol data unit from a transceiver to a subscriber unit is exceeded. This can happen when some of the sub-protocol data units are not being properly received even after being retransmitted. Transmitted a pseudo response prevents the subscriber unit from being tied up. Errors in the transmission can be compensated for at a higher layer of protocol data unit transmission management.

Transmitter (Transceiver) Window

For the purposes of this invention, a transmitter window is defined as a number of sub-protocol data units that have been transmitted without the transceiver having received a response to an acknowledge request. The window can set a limit on the number of sub-protocol data units that are transmitted without a response to an acknowledge request.

Several events can occur if the transmitter window is exceeded. The transmitter can stop transmitting additional sub-protocol data units, or the transmitter can select a particular sub-protocol unit and retransmit the selected sub-protocol unit with an active acknowledge request repeatedly until a response is received. If a response is received, the transceiver retransmits the sub-protocol data units as indicated by the response. If a response is not received, then the transceiver can purge the transceiver buffer of all or some of the sub-protocol data units stored within the buffer.

The transceiver windowing prevents the buffers within the transceiver from over-writing or purging sub-protocol data unit before the sub-protocol data units have all been properly received by a subscriber unit. That is, the transceiver limits the number of sub-protocol data units transmitted without a response to an acknowledge request. Once the limit (window) is reached, the transceiver makes a decision about how to handle the sub-protocol data units within the buffers of the transceiver before storing additional sub-protocol data units. This can include purging the transceiver buffers, or modifying the acknowledgement request process.

Multiple transmitter antennae and/or multiple receiver antennae allow the wireless communication system to include spatial multiplexing and communication diversity. As described earlier, spatial multiplexing and communication diversity can improve the capacity of the communication system and reduce the effects of fading and multi-path resulting in increased capacity.

A poor quality link can require the transmitted data to be coded to minimize the error rate of the transmitted data. Generally, coding of the transmitted information reduces the rate the data is transmitted because the coding adds additional coding data. Examples of the types of coding used include convolutional coding and Reed Solomon coding. These common types of coding are well known in the field of communications.

As previously stated, the mode assignment determines the amount of information transmitted within each data block. Generally, the better the quality of the transmission link between a base transceiver station and a subscriber unit, the higher the mode assignment, and the greater the amount of information transmitted per data block.

It should be understood that the mode assignment of transmission links between base transceiver stations and subscriber units can vary from subscriber unit to subscriber unit. It should also be understood that the mode assignment of a transmission link between a base transceiver station and a subscriber unit can change from time frame to time frame.

Although specific embodiments of the invention have been described and illustrated, the invention is not to be limited to the specific forms or arrangements of parts so described and illustrated. The invention is limited only by the appended claims.

What is claimed:

1. A method of wirelessly transmitting and re-transmitting sub-protocol data units between a transceiver and a subscriber unit, the method comprising:
the transceiver receiving standard data units and forming sub-protocol data units,
the transceiver transmitting a plurality of sub-protocol data units to the subscriber unit, a subset of the plurality of sub-protocol data units comprising an acknowledge request indicator;
the subscriber unit receiving the sub-protocol data units;
the subscriber unit transmitting back to the transceiver a response to the acknowledge request indicator, indicating which sub-protocol data units were successfully received by the subscriber unit.

2. The method of wirelessly transmitting and re-transmitting sub-protocol data units of claim 1, further comprising:
the transceiver buffering the sub-protocol data units within transceiver buffers.

3. The method of wirelessly transmitting and re-transmitting sub-protocol data units of claim 2, wherein the transceiver transmits a sub-protocol data unit comprising the acknowledge request indicator when a last sub-protocol data unit within the transceiver buffers to be transmitted is reached.

4. The method of wirelessly transmitting and re-transmitting sub-protocol data units of claim 2, wherein the transceiver transmits a sub-protocol data unit comprising the acknowledge request indicator when a predetermined number of sub-protocol data units have been transmitted since a previous sub-protocol data unit that comprised a previous acknowledge request indicator was transmitted.

5. The method of wirelessly transmitting and re-transmitting sub-protocol data units of claim 1, wherein a frequency in which sub-protocol data units comprising the acknowledge request indicator are transmitted is dependent upon a quality of wireless transmission link between the transceiver and the subscriber unit.

6. The method of wirelessly transmitting and re-transmitting sub-protocol data units of claim 1, wherein how frequently sub-protocol data units comprising the acknowledge request indicator are transmitted is dependent upon a predetermined time duration since the transmitter received a response to an acknowledge request indicator.

7. The method of wirelessly transmitting and re-transmitting sub-protocol data units of claim 1, wherein every transmitted sub-protocol data unit comprises an acknowledge request indicator after a predetermined time duration since the transmitter received a response to an acknowledge request indicator.

8. The method of wirelessly transmitting and re-transmitting sub-protocol data units of claim 1, wherein the response to the acknowledge request includes a bit map that comprises information about which sub-protocol data units have been successfully received by the subscriber.

9. The method of wirelessly transmitting and re-transmitting sub-protocol data units of claim 1, wherein the response to the acknowledge request includes a hole indicator that indicates which sub-protocol data units of a receiver window that includes a predetermined number of sub-protocol data units were not successfully received by the subscriber unit.

10. The method of wirelessly transmitting and re-transmitting sub-protocol data units of claim 1, further comprising:
the transceiver re-transmitting the sub-protocol data units that were not successfully received by the subscriber unit.

11. The method of wirelessly transmitting and re-transmitting sub-protocol data units of claim 10, wherein the re-transmitted sub-protocol data unit are provided with a different transmission priority than sub-protocol data unit that have not yet been transmitted.

12. The method of wirelessly transmitting and re-transmitting sub-protocol data units of claim 10, wherein the re-transmitted sub-protocol data unit are provided with a different transmission mode than sub-protocol data units that have not yet been transmitted.

13. The method of wirelessly transmitting and re-transmitting sub-protocol data units of claim 10, wherein the transmitted and re-transmitted sub-protocol data units are transmitted over a multiple channel transmission system, and the re-transmitted sub-protocol data units are transmitted over a higher quality channel than a channel in which the sub-protocol data units were initially transmitted.

14. The method of wirelessly transmitting and re-transmitting sub-protocol data units of claim 2, wherein the transceiver aborts a transceiver buffer of sub-protocol data units if a response to an acknowledge request is not received after a given period of time.

15. The method of wirelessly transmitting and re-transmitting sub-protocol data units of claim 2, wherein the transceiver clears a present transceiver buffer when the response to the acknowledge request has been received, and all sub-protocol data units have been successfully received by the subscriber unit.

16. The method of wirelessly transmitting and re-transmitting sub-protocol data units of claim 1, wherein the subscriber unit comprises a subscriber buffer in which received sub-protocol data units are buffered.

17. The method of wirelessly transmitting and re-transmitting sub-protocol data units of claim 16, further comprising:
the subscriber unit aborting the subscriber buffer of received sub-protocol data units if sub-protocol data units with errors are not correctly retransmitted after a given period of time.

18. The method of wirelessly transmitting and re-transmitting sub-protocol data units of claim 1, wherein the subscriber unit transmits a pseudo response to an acknowledgement indicator if the subscriber fails to receive re-transmitted sub-protocol data units after a predetermined amount of time.

19. A method of wirelessly transmitting and re-transmitting sub-protocol data units from a transceiver, the method comprising:
the transceiver receiving standard data units and forming sub-protocol data units,
the transceiver transmitting a plurality of sub-protocol data units to a subscriber unit, a subset of the plurality of sub-protocol data units comprising an acknowledge request indicator;
the transceiver receiving a response to at least one acknowledge request indicator, each response including an indication of which sub-protocol data units were successfully received by the subscriber unit; and
the transceiver re-transmitting the sub-protocol data units that were not successfully received by the subscriber unit.

20. The method of wirelessly transmitting and re-transmitting sub-protocol data units of claim 19, further comprising:
the transceiver buffering the sub-protocol data units within transceiver buffers.

21. The method of wirelessly transmitting and re-transmitting sub-protocol data units of claim 20, wherein the transceiver transmits a sub-protocol data unit comprising the acknowledge request indicator when a last sub-protocol data unit within the transceiver buffers to be transmitted is reached.

22. The method of wirelessly transmitting and re-transmitting sub-protocol data units of claim 20, wherein the transceiver transmits a sub-protocol data unit comprising the acknowledge request indicator when a predetermined number of sub-protocol data units have been transmitted since a previous sub-protocol data unit that comprised a previous acknowledge request indicator was transmitted.

23. The method of wireles sly transmitting and re-transmitting sub-protocol data units of claim 19, wherein a frequency in which sub-protocol data units comprising the acknowledge request indicator are transmitted is dependent upon a quality of wireless transmission link between the transceiver and the subscriber unit.

24. The method of wirelessly transmitting and re-transmitting sub-protocol data units of claim 19, wherein how frequency sub-protocol data units comprising the acknowledge request indicator are transmitted is dependent upon a predetermined time duration since the transmitter received a response to an acknowledge request indicator.

25. The method of wirelessly transmitting and re-transmitting sub-protocol data units of claim 19, wherein ever y transmitted sub-protocol data unit comprises an acknowledge request indicator after a predetermined time duration since the transmitter received a response to an acknowledge request indicator.

26. The method of wirelessly transmitting and re-transmitting sub-protocol data units of claim 10, wherein the re-transmitted sub-protocol data unit are provided with a different transmission priority than sub-protocol data unit that have not yet been transmitted.

27. The method of wirelessly transmitting and re-transmitting sub-protocol data units of claim 19, wherein the re-transmitted sub-protocol data unit are provided with a different transmission mode than sub-protocol data units that have not yet been transmitted.

28. The method of wirelessly transmitting and re-transmitting sub-protocol data units of claim 19, wherein the re-transmitted sub-protocol data unit are transmitted over a better of multiple transmission channels of a multiple antennae transmitter.

29. The method of wirelessly transmitting and re-transmitting sub-protocol data units of claim 20, wherein the transceiver aborts a transceiver buffer of sub-protocol data units if a response to an acknowledge request is not received after a given period of time.

30. The method of wirelessly transmitting and re-transmitting sub-protocol data units of claim 20, wherein the transceiver clears a present transceiver buffer when the response to the acknowledge request has been received, and all sub-protocol data units have been successfully received by the subscriber unit.
